(19) United States
(12) Patent Application Publication
(10) Pub. No.: US 2006/0162875 A1
(43) Pub. Date: Jul. 27, 2006

(54) Overlay members for sectional overhead door panels

(75) Inventors: Brian M. Magill, Cincinnati, OH (US); Jeffrey W. Stone, Lebanon, OH (US); John A. Colston, Mason, OH (US)

Correspondence Address: WOOD, HERRON & EVANS, LLP, 2700 CAREW TOWER, 441 VINE STREET, CINCINNATI, OH, 45202, US

(73) Assignee: Clopay Building Products R&D Company, Inc.

(21) Appl. No.: 11/338,290

(22) Filed: Jan. 24, 2006

Related U.S. Application Data
(60) Provisional application No. 60/646,937, filed on Jan. 25, 2005.

(51) Int. Cl. E05D 15/16

(52) U.S. Cl. 160/201

(57) ABSTRACT

A sectional overhead door is customized by including overlay members selectively mounted to the panels. The front face of the panels may have a design stamped or embossed therein to simulate the vertical slats of a wooden carriage house door. The door panels and the resulting door is customized with the addition of overlay members simulating the transverse or diagonal wood slats on traditional carriage house doors. The overlay members are selectively mounted to the front skin of the door panels at a variety of locations and orientations to mate with the design on the front skin of the panels.

This claims the benefit of U.S. Provisional Patent Application Ser. No. 60/646,937, filed Jan. 25, 2005, which application is hereby incorporated by reference in its entirety.

### BACKGROUND OF THE INVENTION

This invention relates to sectional doors. More specifically, this invention relates to sectional overhead doors that replicate wood sectional carriage house garage doors.

A typical overhead garage door is constructed from a series of door panels, which are hinged together and supported from a track system with rollers attached to opposite ends of the door panels. The rollers allow the door to be moved from a vertically oriented closed position to a substantially horizontal open position. Electrically powered garage door openers are often used with the overhead garage door so that a user may conveniently open and close the door with ease.

In most residential applications, an overhead garage door is generally either eight or sixteen feet wide. Typically, such a door includes four horizontally oriented door panels, each of which is about eight or sixteen feet wide and twenty-one inches high. For example, a single car residential garage may have an eight foot wide by seven foot high door. Likewise, a two car residential garage may have a single sixteen foot wide door by seven foot high door or two eight foot wide by seven foot high doors.

Some of the earliest doors made for garages were one piece barn doors that operated horizontally as large swinging or sliding doors. The nostalgic design of these doors is replicated in wood sectional carriage house garage doors. Wood sectional carriage house garage doors are particularly desirable for use with older homes to maintain the historic design of the home while gaining the convenience and other benefits of the modern overhead garage door. Carriage house garage doors are also desirable with newer homes for enhancing the overall appearance of the garage and consequently the house. Carriage house doors often include a series of vertical wooden slats in a perimeter frame. Commonly, one or more diagonal or transverse wooden slats overlay the vertical slats for added strength and rigidity to the door.

A sectional carriage house door functions like a typical overhead garage door in that it moves on a track and roller system to open and close the door. However, the appearance of the sectional carriage house door simulates the historic swing type doors used in early automobile shelters. The historic appearance of the sectional carriage house door may be created by various types of wood siding, wood slats, wood trim boards, and/or wood raised panels.

Unfortunately, a wood carriage house garage door is very costly relative to a conventional steel overhead garage door. This cost is due in part to labor costs for the largely manual process of constructing the wood carriage house door. Furthermore, the material cost for the wood siding, wood slats, wood trim boards, and/or wood raised panels is undesirably high. Thus, a homeowner may pay five to six times more for a wood carriage house door than for a conventional steel overhead door.

In addition to the costly initial investment, wood carriage house doors are costly to maintain. In particular, the wood is adversely affected by the elements. That is sun, rain, snow, varying temperatures, and so forth may degrade the finish of the wood and eventually cause the wood to warp, split, or rot if not properly treated and maintained. Consequently, the wood carriage house garage door should be resealed or re-painted every couple of years to maintain the aesthetic appearance and integrity of the wood carriage house garage door. This labor intensive and costly maintenance is highly undesirable to the typical homeowner.

Another problem with a wood carriage house garage door results from the weight of the wood siding, wood trim board, and/or wood raised panels, which typically adds one hundred to two hundred pounds to the overall weight of the sectional carriage house door. In particular, the wood or steel open frame door sections often lack the structural integrity or the strength to adequately support the added weight of the wood siding.

Some recent garage door designs attempt to gain the benefits of modern steel overhead sectional door technology and simulate the aesthetic appeal of traditional carriage house doors. Doors of this type have a series of embossed designs simulating vertical and transverse slats stamped into the metal skin of the door panel to present the appearance of a carriage house door. However, due to the nature of the manufacturing process for such doors, the designs can not be changed or modified post production. In many cases, the homeowner desires a customized carriage house door adapted to their particular tastes and aesthetic presentation. This is very costly with known carriage house simulated steel garage doors, if possible at all.

Thus, an overhead garage door that is affordable, durable, low maintenance, impervious to weather and insects, and replicates the appearance of the historic swing type doors used in early automobile shelters and which is capable of being customized to satisfy specific design schemes is desired.

### SUMMARY OF THE INVENTION

The various embodiments of this invention offer these and other advantages over known overhead door and panel designs. In one embodiment, this invention includes a number of horizontally oriented panels vertically stacked one upon the other in edge-to-edge relationship to simulate a carriage house door.

The panels are coupled to a track assembly mounted proximate the garage, warehouse or other opening. The track assembly includes a generally vertical section, a generally horizontal section and a curved transition section joining the horizontal and vertical sections together. Rollers are mounted on the panels and coupled to the track assembly to guide the door between a closed generally vertical configuration with the upper and lower edges of the adjacent panels mated together and an open generally horizontal configuration extending generally parallel to the ceiling of the garage or the like.

One aspect of this invention includes a door panel having a front skin presenting an exterior front face and an optional back skin presenting an interior back face. The skins in one embodiment are metal and the panels are filled with a foam or other insulating material. The panels each have mating upper and lower edges that mate the adjacent panels.

The front skin has a design stamped or embossed into the metal to simulate the vertical slats of a wooden carriage house door. The design may include any number of simulated vertical wood slats, in certain embodiments four to nine slats, and may be repeated on each door panel. The door panels and the resulting door may be customized with the addition of overlay members simulating a variety of designs, including the transverse or diagonal wood slats on traditional carriage house doors. The overlay members are selectively mounted to the front skin of the door panels at a variety of locations and orientations to mate with the design stamped or embossed into the front skin. In certain embodiments, the overlay members simulate a cross-buck pattern. The individual overlay members simulate a single transverse or diagonal slat or a pair such slats intersecting to form an X shape. The placement of the overlay members on one panel may be customized to particular tastes and coordinate with the appearance of the other panels of the overhead garage door.

As a result of this invention, the traditional carriage house style door is available with the benefits of modern steel sectional overhead doors and can be customized with the selective addition of overlay members simulating transverse wood slats complimenting the carriage house style motif.

### BRIEF DESCRIPTION OF THE DRAWINGS

The objectives and features of the invention will become more readily apparent from the following detailed description taken in conjunction with the accompanying drawings in which:

FIG. 1 is a perspective view of an overhead door with associated panels pivotal joined together by hinges and mounted to tracks for opening and closing according to one embodiment of this invention;

FIG. 2 is a perspective view of the front skin of one panel of the overhead door of FIG. 1 with the addition of an overlay member according to one embodiment of this invention mounted thereto;

FIG. 3 is an enlarged view of the encircled region 3 of FIG. 2;

FIG. 4 is a front elevational view of an overhead door panel with a pair of overlay members according to an alternative embodiment of this invention mounted thereto;

FIG. 5 is a front elevational view of an overhead door with overlay members mounted thereto according to a further alternative embodiment of this invention;

FIG. 6 is a cross sectional view of an overlay member being mounted to the front skin of a door panel according to one embodiment of this invention;

FIG. 7 is a view similar to FIG. 6 with the overlay member mounted to the front skin;

FIG. 8 is an enlarged view of the encircled region 8 of FIG. 7;

FIG. 9 is a front elevational view of an overhead door with overlay members mounted thereto according to a further alternative embodiment of this invention;

FIG. 10 is a cross sectional view of an overlay member being mounted to the front skin of a door panel according to an alternative embodiment of this invention;

FIG. 11 is a view similar to FIG. 10 with the overlay member mounted to the front skin;

FIG. 12 is a cross sectional view of an overlay member being mounted to the front skin of a door panel according to a further alternative embodiment of this invention; and

FIG. 13 is a view similar to FIG. 12 with the overlay member mounted to the front skin.

### DETAILED DESCRIPTION OF THE INVENTION

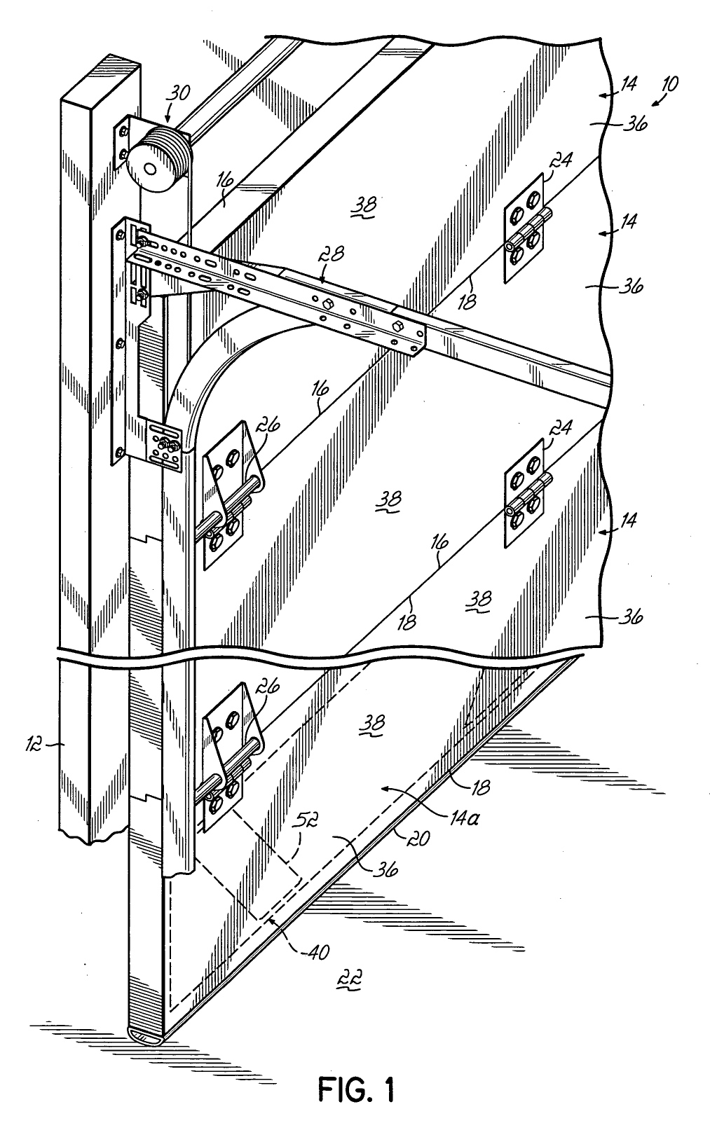

Referring to FIG. 1, a presently preferred embodiment of a portion of an overhead door 10 according to this invention is shown in a closed generally vertical configuration covering an opening in a wall 12 of a garage, warehouse or the like. The door 10 includes a number of panels 14. Each panel 14 includes upper and lower generally horizontally oriented edges 16, 18 which are configured to mate with the lower and upper edges 18, 16 respectively, of an adjacent panel 14 when the door 10 is in the closed configuration as shown in FIG. 1. The lowermost panel 14a of the door 10 includes an astragal 20 for sealing the door 10 against a floor 22.

The adjacent panels 14 are pivotally connected together by a number of hinge assemblies 24. The hinges 24 proximate the lateral side ends of each panel 14 include a roller assembly 26 for coupling the door 10 to a track assembly 28. The opening and closing of the door 10 may be assisted by a counterbalance system 30 coupled to the door 10 as is well known in the art.

The track assembly 28, counterbalance system 30, hinge assemblies 24, top and bottom edge 16, 18 configurations and roller assemblies 26 shown in FIG. 1 are exemplary only and one of ordinary skill in the art will readily recognize that other such components can readily be employed with this invention.

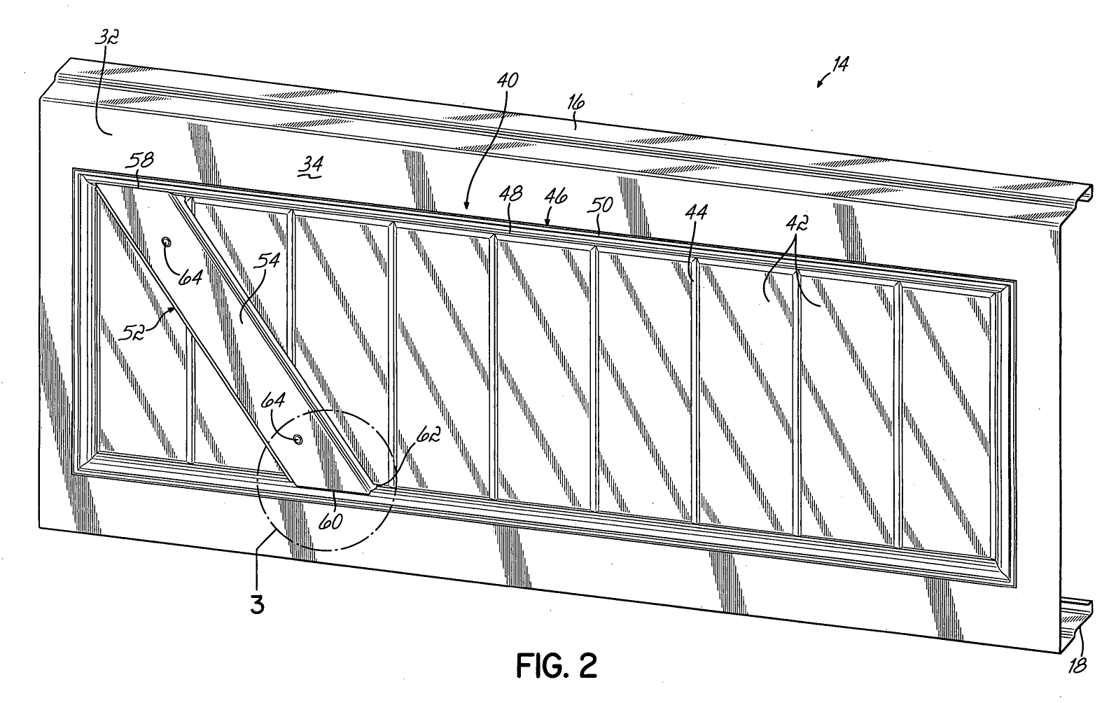

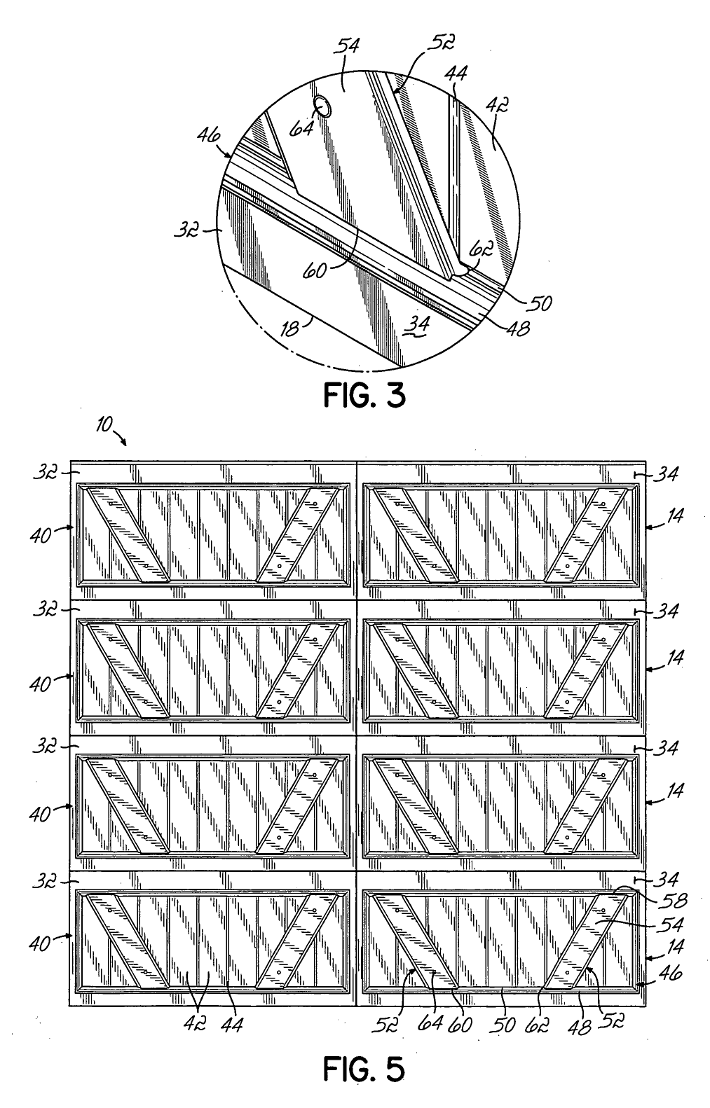

Referring particularly to FIG. 2, each panel 14 according to the various embodiments in this invention includes a front skin 32 defining a front face 34 of the panel 14 and may include a back skin 36 (see FIG. 1) defining, at least in part, a back face 38 of the panel 14. In certain embodiments, each of the skins 32, 36 are metal, steel, thermoplastic or another suitable material. The front skin 32 includes a design 40 formed therein which, in certain embodiments, simulates a series of vertical slats 42 separated from each other by a channel 44. The design 40 may be repeated on a given panel front skin 32 as shown in FIG. 5. In certain embodiments, the design 40 is spaced from the upper and lower edges 16, 18 of the panel as well as the lateral ends of the panel 14. While this invention is shown and described herein with respect to a carriage house-style motif, other designs and styles are readily employed within the scope of this invention.

The vertical slats are surrounded by a perimeter frame 46 which, in certain embodiments, includes a series of generally concave ridges 48 and convex grooves 50. While certain embodiments of the design 40 and associated components are shown herein, this invention is not limited to any particular design 40, frame 46, slat 42 or channel 44 configuration, arrangement or embodiment.

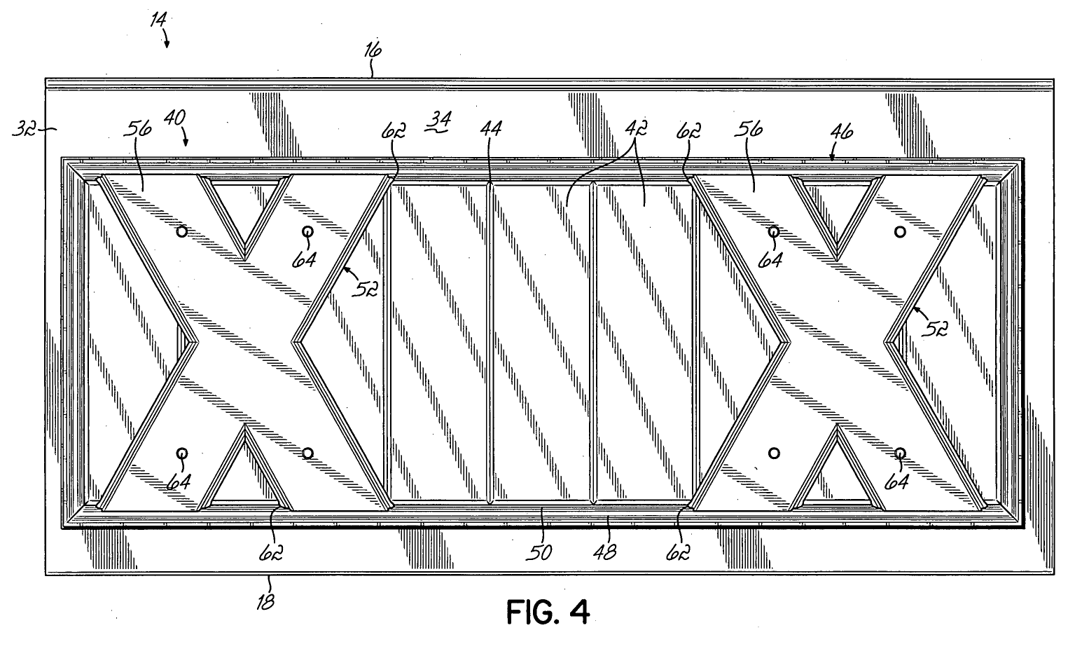

One feature of this invention is the selective addition of one or more overlay members 52 to the front skin 32 of selected panels 14 of the door 10. In various embodiments, the overlay member 52 simulates a single transverse slat 54 (FIGS. 2 and 5), a pair of intersecting transverse slats 56 in an X configuration (FIG. 4) and an arched capping member 76 (FIG. 9).

The overlay members 52 each mate with the design on the front skin 32 of the panel 14. Specifically, each overlay member 52 in some embodiments includes an upper and a lower edge 58, 60 each of which is sized and configured to mate with the perimeter frame 46 of the design 40 in certain embodiments. The upper and lower edges 58, 60 each include a protruding lip 62 which seats within one of the convex grooves 50 of the frame 46 to mate the overlay member 52 to the design 40. In this way, the overlay member 52 is positioned vertically on the front face 34 of the panel 14 in conjunction with the design 40. Advantageously, the overlay members 52 can be selectively positioned at a variety of locations or orientations on the panel 14. In one embodiment, the overlay member 52 can be mated horizontally at a variety of locations within the design 40 in that the lip 62 is capable of being seated in the convex groove 50 of the design 40 along substantially the entire longitudinal length of the frame 46. Moreover, one or more overlay members 52 can be mounted to the front skin 32 of the panel 14 to create a customized carriage house style facade to the overhead door 10 without the added expense of multiple different design configurations and arrangements formed in the front skin 32.

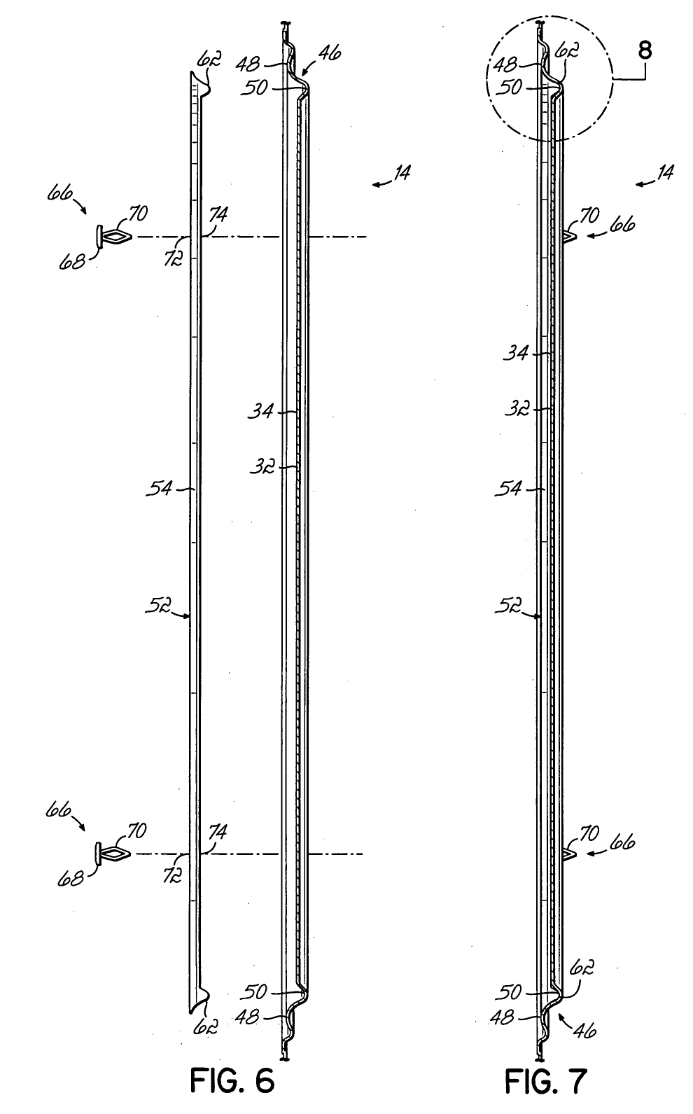

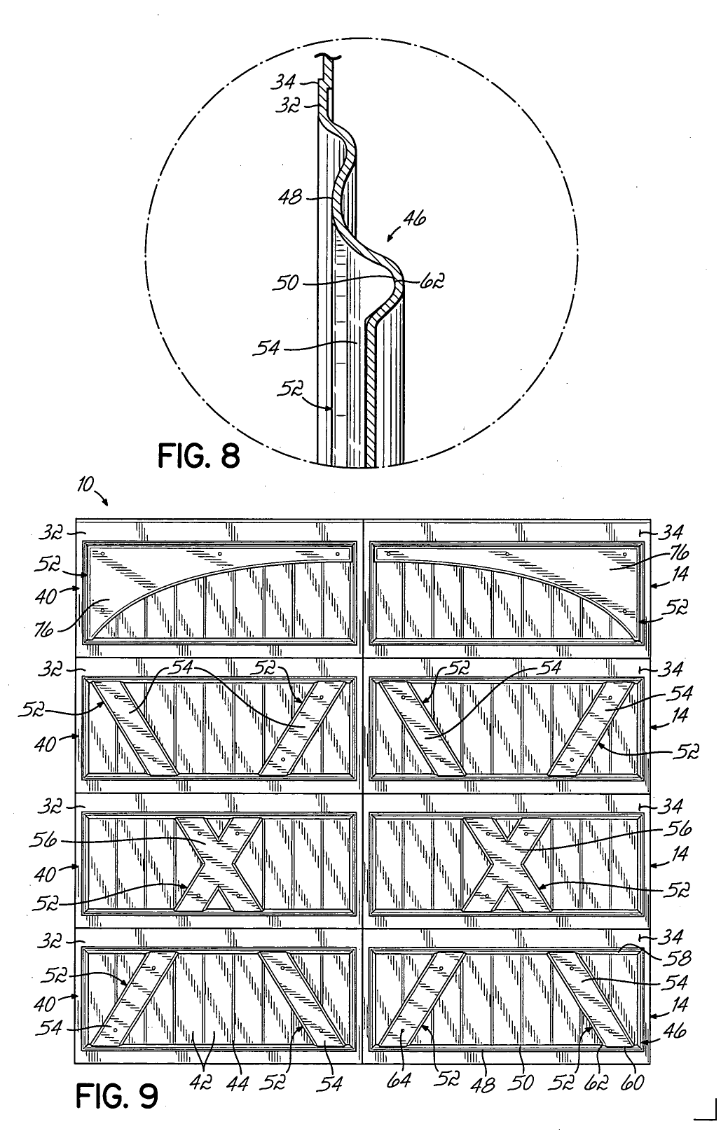

A variety of different attachment mechanisms 64 can be employed to mount the overlay members 52 to the front skin 32 of the panel 14, including adhesives, mechanical fasteners, interlocking mechanisms, snap fit engagement and combinations thereof. One example of such an attachment mechanism 64 is a mechanical fastener in the form of a push pin 66, canoe clip or the like as shown in FIGS. 6-7. The push pin 66 includes a flattened head 68 and opposed spring legs forming a shank 70 of the pin 66. The push pin 66 is manually inserted into aligned holes 72, 74 in the overlay member 52 and the front skin 32. During insertion, the opposed legs of the shank 70 collapse together until the head 68 is seated on the face of the overlay member 52. Once inserted in the holes 72, 74, the legs of the shank 70 expand to secure the push pin 66 and the overlay member 52 to the panel 14. Sealant (not shown) may be applied to prevent the ingress of water or moisture at the site and other areas of the overlay member 52 and front skin 32 interface. It will be appreciated that a wide variety of other attachment mechanisms 64 can be used with this invention.

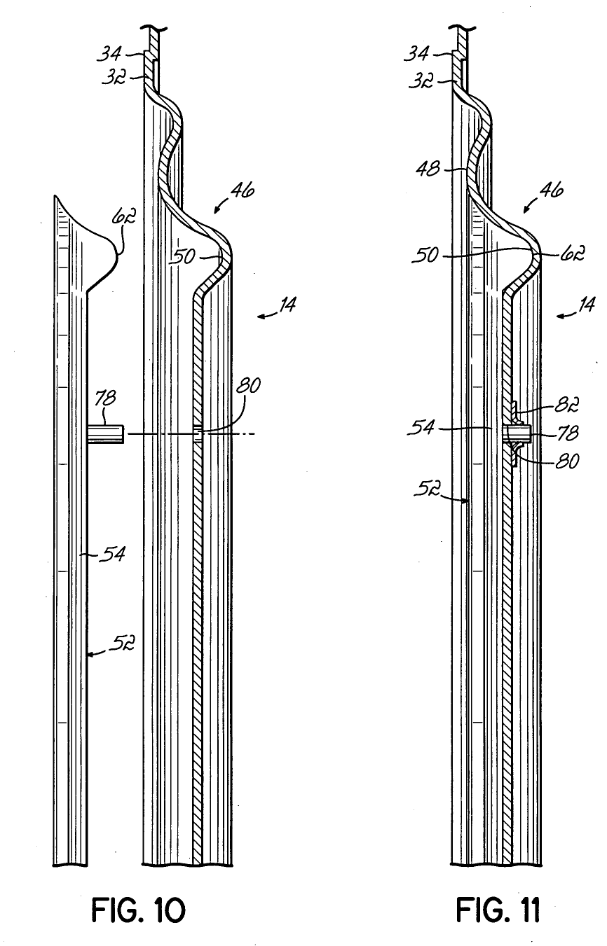

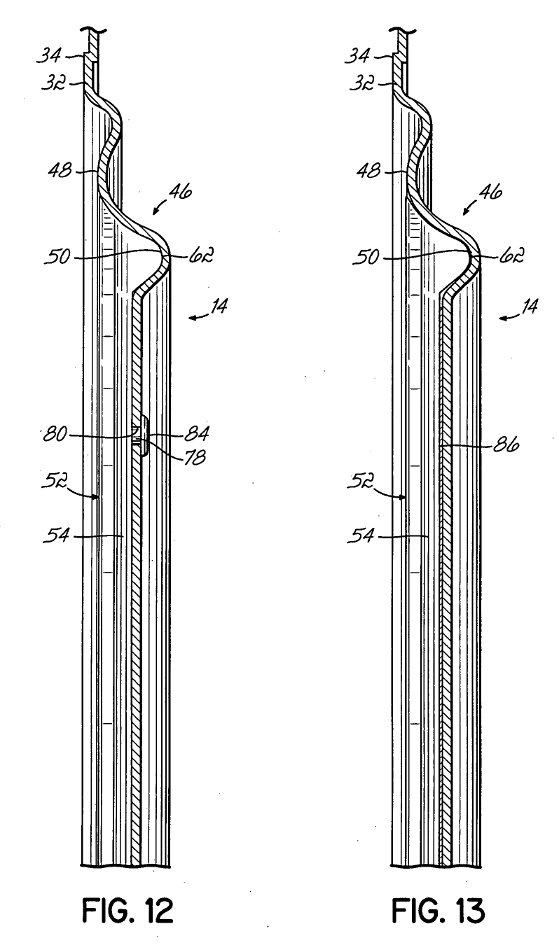

Another attachment mechanism is shown in FIGS. 10-11 which includes a generally cylindrical post 78 extending rearwardly from the overlay member 52. The post 78 is aligned with a hole 80 in the front skin 32 of the panel 14. Although one post 78 and one mating hole 80 are shown in FIGS. 10 and 11, it is readily appreciated that multiple strategically positioned posts 78 may be included on the overlay member 52 for alignment and insertion through associated holes 80 in the front skin 32. Once the overlay member 52 is mated with the front skin 32 and the posts 78 project through the holes 80 in the front skin 32, a self-locking push-on-type fastener 82 is installed on the post 78 to secure the overlay member 52 to the panel 14. One example of such a push-on fastener 82 is a Tinnerman nut (www.tinnerman.com). Once the desired location and orientation of the overlay member 52 is determined, the appropriate hole(s) 80 are made in the front skin 32 as needed, if any.

As a further alternative attachment mechanism 64, the post 78 and associated overlay member 52 may be heat staked to the front skin 32 of the panel 14. After the post 78 is inserted through the hole 80, the rearwardly protruding portion of the post 78 is melted into a mushroom-shaped cap 84 and the overlay member 52 is then staked to the front skin 32.

A further option for the attachment mechanism 64 is a double-sided high bond tape 86 as shown in FIG. 13. The double-sided tape 86 is positioned between the overlay member 52 and the front skin 32 to provide a bond there between. One advantage of the tape 86 is that no holes are required in the front skin 32. One example of such a tape is available from 3M as tape 4052.

One advantage of this invention is the ability to provide compatible thermal expansion between the overlay member 52 and the front skin 32 of the panel 14. As such, one material which is suitable for the overlay member 52 is available from General Electric as GE Cycoloy® 4220. The coefficient of thermal expansion for the overlay member 52 is about 20.1×10⁻⁶ in/in/° F. and for the front skin is about 6.3×10⁻⁶ in/in/° F. This and other compatible materials for the overlay members 52 should be paintable, durable and have a comparable thermal expansion to the material of the front skin 32. Moreover, the overlay member 52 should accept an embossed pattern such as a wood grain texture or the like for compatible aesthetic appearance with any embossed wood grain pattern or the like on the front skin 32.

As a result of this invention, the traditional carriage house style door is available with the benefits of modern steel sectional overhead doors and can be customized with the selective addition of overlay members at a variety of positions, orientations and configurations to enhance and customize the aesthetic appearance of the door 10.

It should be readily appreciated that although certain embodiments and configurations of the invention are shown and described herein, the invention is not so limited. From the above disclosure of the general principles of the present invention and the preceding detailed description of various embodiments, those skilled in the art will readily comprehend the various modifications to which this invention is susceptible. For example, while the invention is described herein with reference to a steel skin carriage style door with an embossed design pattern, other designs, styles, motifs, and materials could be utilized within the scope of this invention. Therefore, we desire to be limited only by the scope of the following claims and equivalents thereof.

We claim:

1. An overhead door capable of being selectively moved between a generally horizontal open position and a generally vertical closed position covering an opening, the door comprising:
a plurality of serially connected panels each having a front face, a top rail and a bottom rail, the top and bottom rails each being adapted to mate with the bottom rail and top rail, respectively, of an adjacent panel;
a track assembly mounted proximate the opening, the track assembly including a generally vertical section, a generally horizontal section and a transition section joining the horizontal and vertical sections together;
a plurality of rollers mounted on the panels and coupled to the track assembly to guide the door between the closed and open positions;
a plurality of hinge assemblies each mounted to the adjacent panels to pivotally couple the adjacent panels together;
a non-planar design on the front face of at least one of the panels; and
an overlay member mounted to the front face of the at least one panel and mated with the design.

2. The overhead door of claim 1 wherein the overlay member is adapted to be mounted to the design at a plurality of locations on the front face.

3. The overhead door of claim 1 wherein the overlay member is adapted to be mounted to the design in a plurality of orientations on the front face.

4. The overhead door of claim 1 further comprising:
an attachment mechanism securing the overlay member to the front face.

5. The overhead door of claim 1 wherein the non-planar design further comprises a concave groove and the overlay member further comprises a lip adapted to mate in the concave groove.

6. The overhead door of claim 1 wherein the overlay member is spaced from at least one of the top and bottom rails of the at least one panel.

7. The overhead door of claim 1 further comprising a plurality of the overlay members and a plurality of the non-planar designs on a plurality of the panels.

8. The overhead door of claim 4 wherein the attachment mechanism is selected from the group comprising:
(a) double sided adhesive tape,
(b) pin adapted to be inserted into aligned holes in the overlay member and the front face, and
(c) a post projecting from the overlay member and adapted to be inserted into an aperture in the front face.

9. The overhead door of claim 1 wherein the design further comprises a generally rectangular perimeter frame having a series of grooves and ridges, the design further including a series of evenly spaced channels formed in the interior of the frame.

10. The overhead door of claim 1 wherein each overlay member covers less than the entirety of the design to which it is mated.

11. A method of making panels for use with other such panels in an overhead door, the method comprising the steps of:
forming a non-planar design in front skin on a front face of a first panel;
selectively locating a first overlay member at a first one of a plurality of compatible locations relative to the design on the first panel;
selectively locating a second overlay member at a second one of the plurality of locations relative to the design on the first panel;
mating the overlay members to the design; and
attaching the overlay members to the front skin of the first panel at the respective selected locations relative to the design.

12. The method of claim 11 wherein the first and second overlay members are substantially identical to each other.

13. The method of claim 11 wherein the forming step further comprises stamping the design in the front skin of the first panel.

14. The method of claim 11 wherein the mating step further comprises positioning a lip projecting from each of the respective overlay members into a groove of the design.

15. The method of claim 11 wherein the overlay members cover less than the entirety of the design to which they are mated.

16. The method of claim 11 wherein the attaching step further comprises at least one of the following:
inserting a post projecting from the respective overlay member into a hole in the front skin of the associated panel and mounting a push-nut on the post;
inserting the post projecting from the respective overlay member into the hole in the front skin of the associated panel and deforming a distal end of the post;
inserting a pin through an aperture in the respective overlay member into the hole in the front skin of the associated panel; and
applying an adhesive layer between the respective overlay member and the associated panel.

17. A method of making panels for use with other such panels in an overhead door, the method comprising the steps of:
forming substantially identical non-planar designs in front skins on a front faces of a first and a second panel;
selectively locating a first overlay member at a first one of a plurality of compatible locations relative to the design on the first panel;
selectively locating a second overlay member at a second one of the plurality of locations relative to the design on the second panel;
mating the overlay members to the design; and
attaching the overlay members to the front skins of the respective panels at the respective selected locations relative to the designs.

18. The method of claim 17 wherein the first and second overlay members are substantially identical to one another.

19. The method of claim 17 further comprising:
selectively locating a third overlay member at a third one of the plurality of compatible locations relative to the design on the first panel;
mating the third overlay member to the design; and
attaching the third overlay member to the front skin of the first panel at the third selected location relative to the design.

20. The method of claim 17 wherein the attaching step further comprises at least one of the following:
inserting a post projecting from the respective overlay member into a hole in the front skin of the associated panel and mounting a push-nut on the post;
inserting the post projecting from the respective overlay member into the hole in the front skin of the associated panel and deforming a distal end of the post;
inserting a pin through an aperture in the respective overlay member into the hole in the front skin of the associated panel; and
applying an adhesive layer between the respective overlay member and the associated panel.
